(19) United States
(12) Patent Application Publication
(10) Pub. No.: US 2012/0124103 A1
(43) Pub. Date: May 17, 2012

(54) SYSTEM, A METHOD, AND A COMPUTER PROGRAM PRODUCT FOR TESTING

(76) Inventor: Ofir Epstein, Ness Ziona (IL)

(21) Appl. No.: 13/387,116

(22) PCT Filed: Aug. 28, 2010
(86) PCT No.: PCT/IL10/00605

§ 371 Date: Jan. 26, 2012

Related U.S. Application Data
(60) Provisional application No. 61/229,028, filed on Jul. 28, 2009.

(51) Int. Cl. G06F 7/00

(52) U.S. Cl. 707/803; 707/E17.039

(57) ABSTRACT

System, method and storage medium loaded with a program are provided for preparing tests in which a certain set of questions may be ordered in different order amongst different copies of the test. There further provided a method for setting different order of answers of a multiple-choice type of test for each question, amongst different copies of the test. Further is provided a method and tool for keeping the decoding key for deciphering and reconstructing the order of the questions and answers within the test itself thus allowing checking the answers and providing statistics on virtually any computer, regardless of the computer on which the test was composed. There is further provided a system and method for processing multiple types of inputs for the questions, such as text, graphics, images, equations and the like.

### BACKGROUND OF THE INVENTION

Tools for preparing tests where questions and/or answers to the questions (in a multiple choice type of test) are scrambled in order to prevent copying of answers by neighbors examinees are known in the art. However these tools typically can accept only simple input files, such as those processed in a simple word processor, such as Windows Notepad®. These tools fail also to accept input other than simple text, such as equations, pictures and images, graphs and the like. These tools usually fail also to accept as input font type or size other than a standard font type and size. Another common drawback of known tools for preparing tests is the lack of option to set the page with controllable margins, emphasizing and the like.

Known tools for preparing tests that undergo scrambling create a decoding key that need to be stored on the computer where the filled test will be assessed, or the key or a decoding file need to be transferred to that computer, which is an awkward process. Most of the known tools for processing scrambled tests have a limited support for multi-lingual environments and especially right-to-left languages, such as Hebrew support, or none at all. Some of the known tools for processing scrambled tests limit the user to compose the tests only of questions that come with the tool, and prevent the user from using questions that were freely prepared or composed by the user.

There is a need for a simple, trusty flexible software and system for processing and checking scrambled tests that will support images, graphs, equations and the like, that will enable visual editing and that will be free of a specific computer for checking the tests.

### SUMMARY OF THE INVENTION

A method for preparing a set of tests is provided comprising receiving a set of questions and one set of answers associated with each question of said set of questions, wherein at least one of the answers in each of said set of answers is a correct answer, scrambling the order of questions to create one scrambled set of questions, according a scrambling alphanumeric code to the scrambling of said answers, said alphanumeric code to be used for reconstruction of the scrambled questions into their original order, repeating the steps of scrambling and the step of according to create additional scrambled tests until the set of scrambled tests includes a predefined number of scrambled tests.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A illustrates a method for testing, according to an embodiment of the invention and especially stages relating to the generating of the test;

FIG. 1B illustrates a method for testing, according to an embodiment of the invention, and especially stages relating to the checking/evaluating/processing of some or all of the generated tests;

FIG. 1C illustrates a method for testing, according to an embodiment of the invention, and especially stages relating to the processing of tests result input, especially scanned document; and

FIG. 2, which illustrates system 200 for testing, according to an embodiment of the invention

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements

### DESCRIPTION OF EMBODIMENTS OF THE PRESENT INVENTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method for testing is provided, according to an embodiment of the invention.

The method may start with receiving a test input information, that includes multiple questions, and multiple answers for each of the questions, and at least one correct answer indication for each of the multiple questions, as well as potentially other information (test introduction, additional pages and attachments such as formula pages and others, etc.). It is noted that the receiving of the test input information may be carried out after providing to a user an interface for generating the test information (e.g. a graphic user interface). The test input information may be saved in RTF format, but this is not necessarily so. The test input information may be edited using any editing software application, such as Microsoft Word®, Open Office®, etc. that is adapted to save the edited file in RTF format.

According to an embodiment of the invention, the test input information may include receiving questions that are associated with one another, and/or which are associated to a non-question object such as a text or an image. Such a group of multiple objects (of which at least one object is a question, and the other are either questions and/or non-question objects) is also referred to as a block. A block herein after will be considered as a combination of one or more questions with additional materials such: data, a written story or scenario to be presented with the question, text and/or picture that will be presented to the examinee with the question, and the like. A question or questions in a block will be associated with their respective data, story, text and/or picture, regardless whether, or not, the question or questions have been scrambled or the answers for these questions have been scrambled. The content of a block may not be separated and the block may not be torn. Further, a question or questions associated with one block may not become part of another block. Similarly, additional materials associated with one block may not become part of another block. For example, a block may contain a short story or an image, and few questions which pertain to the image or story. According to embodiments of the present invention an examination may be considered as a bunch of blocks lined in the examination form.

The method may continue with parsing the test input information. Parsing may be done to provide question information for each of the multiple questions (the question information may include, by way of example, a question body, a list of answers, and an indication of one or more correct answers, and a scoring scheme for each of the answers). Question information of the different questions may be saved in a single file or in separate files, in a single memory entry or in multiple memory entries. Parsing may be done also to provide blocks information, blocks header content, block content and information of the beginning of the test. It is noted that the parsing may be carried out as a part of a generation of multiple tests that is carried out after the receiving of the test input information, or independently of which.

The generating of the multiple tests includes generating multiple tests, in which questions out of the multiple questions are ordered in a different order in each of the tests, and/or answers for different questions are ordered in a different order in each of the tests, so that every test of the multiple tests is unique. All the tests may have common information (e.g. the test introductory text, etc.).

It is noted that all the tests generated may have the same number of questions. It is noted that all of the generated tests may include the same questions (wherein the order of the questions and/or answers differs) as the other tests. It is noted that all of the generated tests may include all of the multiple questions. It is noted that the generating of tests may include selecting questions out of the multiple questions in response to one or more selection parameters (e.g. difficulty, topic, etc.). It is noted that the number of generated tests that include different compositions of questions, or different order of answers to the questions may be less than the number of intended examinees, in which case the different compositions of questions or answers are intended for different groups of examinees. It is noted that the generating of the multiple tests may be carried out in different instances (e.g. generate one hundred tests at a first time, and generating additional twenty tests at a later time, e.g. when additional examinees are expected). It is noted that the generating of the tests may include assigning different tests to different examinees (which can be also carried out in a later stage of preparing the tests for providing), e.g. to print in each of the tests identifying details of an examinee. It is noted that different tests may be generated for different examinees/examinees groups. For example, some tests may be generated with a different number of potential answers (e.g. for advanced students). It is noted that tests may be presented/handed to examinee in one or more of various forms and formats, such as printed pages, electronic visible file such as in PDF format, etc. Further, tests may be given to given to examinee in various ways, such handed to examinee, sent to examinee via a computer network, such as the Internet, saved on a server accessible to the examinee, and the like.

As for blocks of questions (or of objects which may also include non-questions objects like reference images), it is noted that each block may be treated as an undividable object when the random order of the questions is determined for each text. It is further noted that, according to an embodiment of the invention, the order of the questions within the block may be randomized for each test, as long as all the questions of the block remain together.

The generating of the tests may usually also include generating of reference information for each of the test, which includes information of the correct answer for each of the questions, as well as potentially additional information, which may be used for example, in evaluating a result of an examinee for this test. The reference information may enable, for example, a human to carry out the evaluation (e.g. a printout of the correct answers for each of the tests, as well as test identifying information), or a machine to carry out the evaluation.

A test may be scrambled. Scrambled test may relate to the creation of multiple copies of one test so that in each copy the order of blocks is different from the order of blocks in any other test and/or so that the order of questions in each block in one test is different than the order of questions in a corresponding block in any other test and/or so that the order of answers (in a multiple choice type of test) of one question is different from the order of answers in a corresponding question in any other test. According to some embodiments of the present invention questions in certain blocks may be defined as static, that is the questions in these blocks will not be scrambled, while their respective answers may be scrambled. According to yet another embodiment certain blocks may be defined as static, that is these blocks will not be scrambled and will remain static in the test.

It is noted that the generating of the tests may include including within each of the tests reference information that enables checking of that test (e.g. checking the correctness of answers provided by examinee to questions in that test) without a need to receive additional data, for example stored information regarding how the scrambling was made, to check the test. It is noted that such an embodiment of the invention may enable checking of the test on a computer other than the one on which the test was generated, without needing to import any additional information, except for that included in the test, for example on the face of the print-out of the test in the form of a key. The key may be common to all the generated tests of the series of test, but this is not necessarily so. It is noted that said coded reference information is contained within, or on the face of each test, for example in the form of a printed alphanumeric string. In order to parse the test the key is entered after the answers were inputted, by scanning or typing, into the computer. Entry of the key enables deciphering of the answers file. The decoding key is typically composed of two parts. One part of the code is common to all tests of the test series and the second part is unique for the answers of each examinee. The code may be numeric or alphanumeric, yet it may have another form. Thus, when a test is to be checked, for example for grading the examinee, that key is used for reconstructing the scrambled file associated with the specific test. It is noted that said key is saved only with the blocks of its respective test and nowhere else. Said key is a is an injective function for scrambling/encrypting and for decrypting of classified/hidden information embedded with the test, such as which is a right answer to a specific question, what is the right order of the multiple choice answers for a specific question, etc.

According to an embodiment of the invention, the reference information that is included in each test (and may be printed with the test, e.g. as a reference code, as a barcode, and so forth), may include, according to an embodiment of the invention, information regarding the number of tests, number of questions, number of answers in each question. Conveniently, the encoding of the reference information to provide the code that ultimately appears on the printed tests may include a coding that is based on random numbers which cannot be recalculated manually.

According to an embodiment of the invention, the reference information that is included in each test (and may be printed with the test, e.g. as a reference code, as a barcode, and so forth), may include the number of blocks, number of questions in each block, and block scrambling options for one or more of the blocks (e.g. whether the questions of the block will be scrambled amongst themselves or not, whether the block itself will be scrambled with the rest of the blocks, or stay stationary, e.g. always in the third/last position).

The generated tests (and at least some of which) are then being prepared for being provided to examinees. The preparing of the tests may include printing the tests out, saving the tests (to one or more files or memory entries, e.g. in a PDF format), displaying the tests on one or more displays (either concurrently or at different times), sending the tests as an electronic communication (e.g. as an e-mail, or as a communication to a dedicated software, etc.), and so forth.

The method may also include, according to an embodiment of the invention, processing results of the tests. In such a case, the method also includes receiving tests results input of one or more of the tests generated. The receiving may include receiving of user-pre-processed results (e.g. human encoded the answers provided by different assignees). The receiving may include receiving the results from a machine on which the tests were conducted (in such an embodiment of the invention). The receiving may include scanning of paper document that includes the filled-in tests, and/or processing scanned document, for determining the answers provided by an assignee to each of the questions.

After the test results are received, the method may continue with providing the results to a user (e.g. if the tests were carried out electronically). The test results may also be used for processing the results, to provide one or more outcomes—such as a scoring for different assignees, statistics, and so forth. It is noted that the providing of the outcomes may be used for modifying the scoring scheme for the tests (e.g. accepting additional correct answers for one or more questions, ignoring a question, and so forth), either automatically, semi-automatically, or by the user.

The process of checking and evaluating a test comprising:
i. The evaluator enters the unique key code to the computer and loads the test;
ii. The system and method of the invention reconstructs the coded test file,
iii. The system and method parses the order of questions and the answers given to them (and that was selected by the examinee);
iv. The system and method accord a grade to the test;
v. Detailed statistical report is calculated and saved in an electronic sheet (or any other similar format) and the results, being primary results, are presented;
vi. The user is allowed to change parameters, such as change of the definition of the right answer, adding grade, granting benefit factor, etc.);
vii. When such change is made its effect on the results and statistics is immediately presented to the user. Similarly, when any other change is made in the test, its statistical effect is immediately presented.

Statistics of test results may use, or refer to the following statistical methods and tools: average, standard deviation (SD), number of examinees, Cronbach's alfa, etc. For each question there may be its own statistics that may present the deviation of correctness of answers among examinees, the correlation figure of the question, Further the amount of students that received a certain grade, in absolute and relative figures. Another output that may be presented to a specific examinee is the actual answer he/she wrote, the right answer, the number of right answers, the grade, the amended grade, if a benefit factor was granted. In yet another embodiment or another selected presentation only the test form number, the examinee ID number and the grade will be presented. In case the test was formed for several groups of examinees, the statistics that will be available for presenting to users will present, additional to the information described above, for each group, an overall statistics, considering all the groups.

It is noted that the processing of the results of the tests may include processing the results manually or automatically (or a combination thereof), and may be carried out on the same computer on which the tests were generated, on another computer, or without a computer at all. According to an embodiment of the invention, the processing of the results of each one of the tests is responsive to reference information (whether encoded or not) that is included within the test (e.g. printed on a bottom of the last page of the test).

Apart from providing results of the evaluation/analysis, the method may also include generating for different tests that were evaluated/analyzed a results document, to be provided to the corresponding examinees (e.g. with marking of the selected answer, of the correct answer, and potentially an explanation regarding the correct/incorrect selected answer).

It is noted that the entire method may also pertain to a test that further includes—apart of the multiple selection questions—one or more open questions, for which the answer requested is not multiple selection. The answers for such questions may and may not be automatically processed, and may and may not be taken into account when determining a score of the test, or another processing result pertaining to the test. It is noted that some variations/randomizations may be entered for open questions as well, when the generating of the multiple tests is carried out.

The results of the tests and/or processing/evaluation may be provided to one or more users using different means (e.g. print-out, display, voice, and so forth), and may be stored in an electronic memory.

It is noted that a computer program product for testing may be provided. The computer program product may include one or more computer readable mediums, having computer readable code incorporated therein, wherein the computer readable code includes instructions for the carrying out of some or all of the different stages of the aforementioned method (or of other methods discussed below), by one or more computers. The computer program of the present invention may be installed on substantially any personal computing means that suit the executable version of the program. In other embodiments the computer program of the present invention may be running on a remote computer or server and be accessed via a suitable network, such as the Internet.

Referring to either the method or the computer program product, it is noted that in different embodiments of the invention, the following may apply:
i. The providing of the interface for generation of the test may include (or come after) creating template files in which the user can fill a multiple-choice test in.
ii. The receiving of the test input information may include reading tests built in a specific format and extracting the questions and answers, reading blocks, reading information embedded in the header of a block and reading information embedded in the beginning of a test.
iii. The generating of the tests may include creating copies of the test. In every copy the questions and answers are in a different order. Further, in different tests the blocks are in different order and in some embodiments the blocks may be in the same order but the questions in a block may be in different order among different tests. Some or all of the following options may be implemented in the generating of the tests:
   1. Font adjustments and fixes.
   2. Shade the test information part.
   3. Create more version of a test that was already created, even if not on the same machine.
   4. Print the tests directly during the creation.
   5. Save the test in one or multiple PDF files.
   6. Force text break in order to make sure there are no page breaks in a question.
   7. Force page-break between the test instructions and the test questions.
   8. Enforce size of page margins.
   9. Add answers pages and/or add draft pages, for example in order to force all tests to have same total number of pages.
   10. Automatically read the template file and parse how many questions and answers are, without the user having to input the numbers.
   11. Setting a first maximal grade for a test that is partial to the full grade, that first maximal grade is associated with a first portion of the test that requires selecting the right answer for each question, and reserving the complementary grade for a second maximal grade, that is associated with the open-test type test portion (where an expected answer is involved with free text, free language form). Answers to the second type portion of the test will not be evaluated by the system and method of the present invention.
   12. Generating or composing of additional questions for future us, storing the additional questions and, when needed, including one or more of the stored additional questions while composing a test.
iv. The evaluating may include checking each test and may also include providing statistics in response to a result of the evaluating (e.g. in Microsoft Excel format).
v. According to an embodiment of the invention, the receiving of the test result input may include reading data from scanning software.
vi. The evaluating and/or the modifying of the scoring scheme (or other evaluation parameters) may include:
   1. Change/add correct questions.
   2. Add partial points to specific answers.
   3. Cancel questions.
   4. Give a correcting grade factor to all of the students.
   5. Give a correcting grade factor to a certain grade range.
   6. Give a questions choice.
   7. Define a maximal grade for a given test. This grade will be assigned to a certain group of questions.
vii. It is noted that the modification made for one test may be used for future generating of other tests (e.g. if the same questions are used in a later time, if a class is determined to be slow, etc.)
viii. It is noted that modifications made in a test as described above may be put on hold and effected at later time, may be effected immediately, may be cancelled after being effected, may be edited at any time before being effected or re-effected.
ix. Conveniently, the check options can be saved, previewed and loaded.
x. Detailed statistics and information about the test may be provided and/or saved in different formats, e.g. in Microsoft Excel® format.
xi. The providing of the evaluation results may include, according to an embodiment of the invention, questions and answers order in a specific test(s).
xii. The method and system of the present invention may be used for the composing of multiple-choice tests and may provide statistics of the success and level of difficulty; they may be used for the composing and info analysis of reviews and exploration; they may be used for composing and evaluating survey of the level of knowledge; and any other similar use that maintains the spirit of the invention.

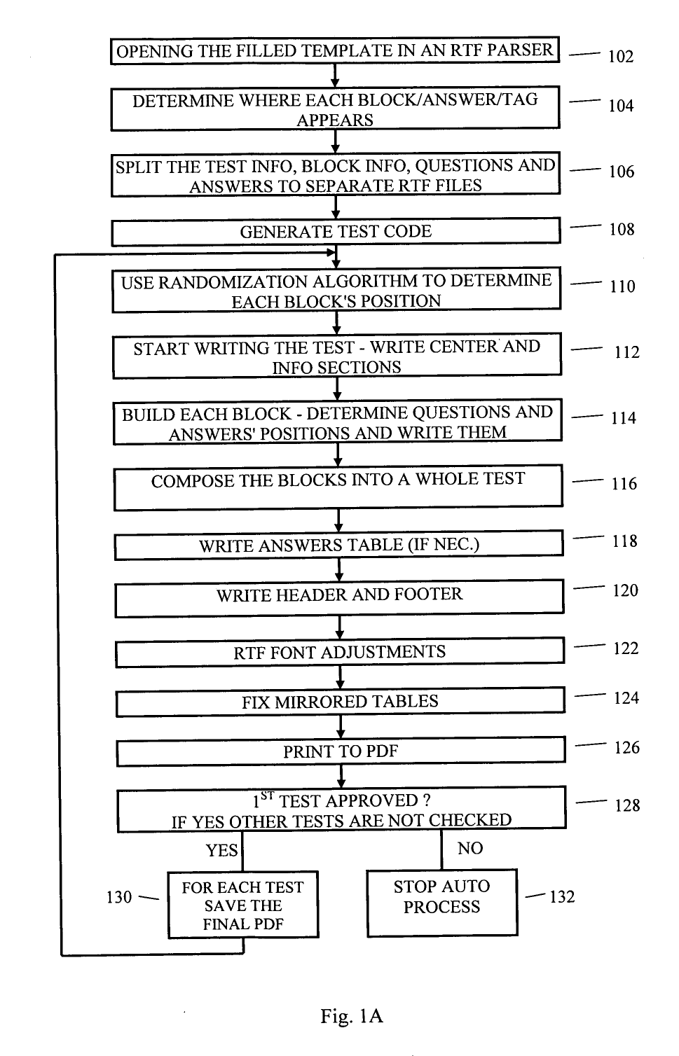

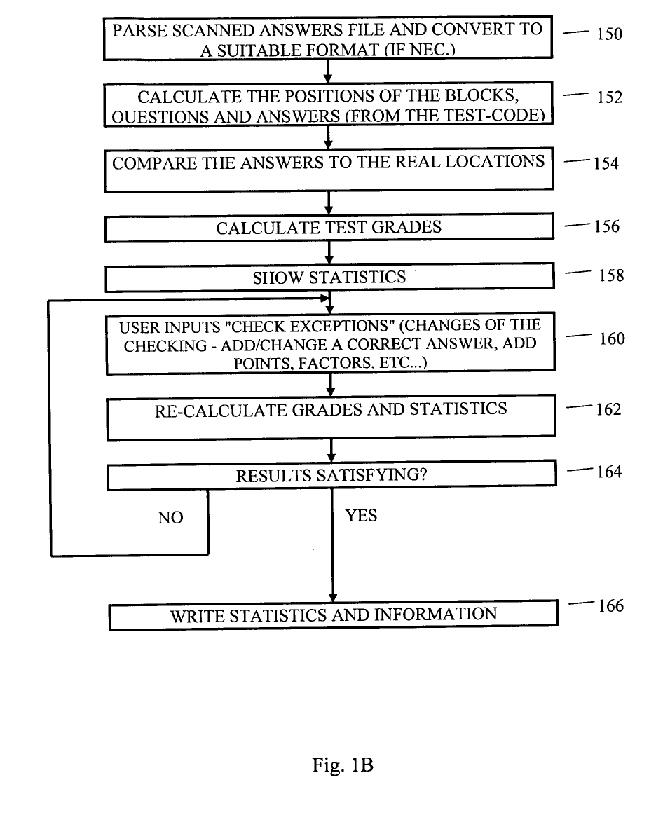

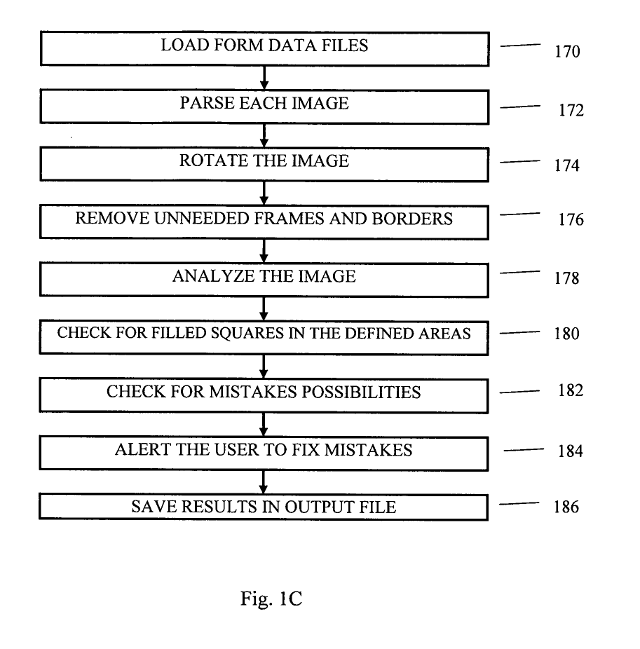

Reference is made to FIG. 1A, which illustrates a method for testing, according to an embodiment of the invention, and especially stages relating to the generating of the test. According to embodiments of the present invention the testing starts with opening a filled template using, for example, a RTF parser (block 102), then determining where each block info, answer, tag, etc. appear in the form (block 104), then splitting the test info, the blocks info, the questions and answers to separate RTF files (block 106). At this stage a code for the test is generated (block 108). Now randomization algorithm may be used to determine the position of each block (block 110). At this stage the test may be written, the center part and the info part are written (block 112) and each block is built, that is the position of each question and answer is determined and the questions and answers are written (block 114). At this stage the ready blocks may be are composed to a test (block 116), answer table may be written (block 118), header and footer are written (block 120), RTF font adjustment is set (block 122) mirrored tables are fixed (block 124), and the test is printed, for example to PDF format (block 126). At this stage the test composer can evaluate the resulting test (block 128). If the test is approved the next test may be composed, by repeating the operations of blocks 110 to 126. If the test is not approved the automatic process is stopped and the user may restart it manually. According to additional or alternative embodiments the scrambling of each question may be done in advance, before the test is composed, and the one or more modes of scrambling of each question will be saved for later use, with the respective question. When the test is prepared instead of writing the question one of the scrambling modes of that question will be selected and loaded, for example using randomization algorithms. It is noted that the method illustrated in FIG. 1A, and/or different stages thereof, may also be used in relation to the method for testing discussed above. Those methods can also be combined, in different variations.

Reference is made now to FIG. 1B, which illustrates a method for testing, according to an embodiment of the invention, and especially stages relating to the checking/evaluating/processing of some or all of the generated tests. The process starts with parsing the scanned answers file and converting to a desired format, as may be necessary (block 150). The positions of the blocks, questions and answers is calculated (using the test code) (block 152), the answers are compared with the correct answers, based on the locations of the answers (block 154) and the test grade is calculated (block 156). At this stage the calculated statistics may be presented (block 158). At this stage, based, for example, on the calculated statistics, the user may intervene in the final grade by, for example, changing the defined correctness of an answer, adding bonus points, granting benefit factor, etc. (block 160) and re-calculate the statistics (block 162). If the resulting grade and/or statistics are satisfying the process may end with writing/saving the final scores and statistics (block 166). In case the resulting grade and/or statistics are not satisfying the operations of blocks 160 to 164 may be repeated until results are satisfying. It is noted that the method illustrated in FIG. 1B, and/or different stages thereof, may also be used in relation to the method for testing discussed above. Those methods can also be combined, in different variations. It is noted that the method of FIG. 1B may be a continuation of the method of FIG. 1A, but this is not necessarily so.

Reference is made now to FIG. 1C, which illustrates a method for testing, according to an embodiment of the invention, and especially stages relating to the processing of tests result input (especially scanned document, but may also be applied to other formats, mutatis mutandis) of some or all of the generated tests. The process starts with loading the form data files (block 170), images in the loaded form are parsed (block 172) and rotated if necessary (block 174) and unneeded frames and border lines are removed (block 176). At this stage the image is analyzed (block 178) and is checked for filled squares in defined areas of the image (block 180). Now the process checks for mistake possibilities (block 182) and alert to the user is issued if needed to fix the mistakes (block 184). Finally, when mistakes have been fixed the results are saved in a file (block 186). It is noted that the method illustrated in FIG. 1C, and/or different stages thereof, may also be used in relation to the method for testing discussed above. Those methods can also be combined, in different variations. It is noted that the method of FIG. 1C may be a continuation of the method of FIG. 1A, and/or be carried before the method of FIG. 1B, but this is not necessarily so.

In relation to FIGS. 1A, 1B, and 1C, it is noted that not all the stages are necessarily carried out in each embodiment of the invention, and that some of the stages may be implemented with different variations without exceeding from the scope of the invention, as will be clear to a person who is skilled in the art. For examples, different file formats may be used, etc.

It is noted that a computer program product for testing may be provided. The computer program product may include one or more computer readable mediums, having computer readable code incorporated therein, wherein the computer readable code includes instructions for the carrying out of some or all of the different stages of any of the above referenced methods, by one or more computers. It is noted that the computer readable code may include instructions for the execution of stages of different methods.

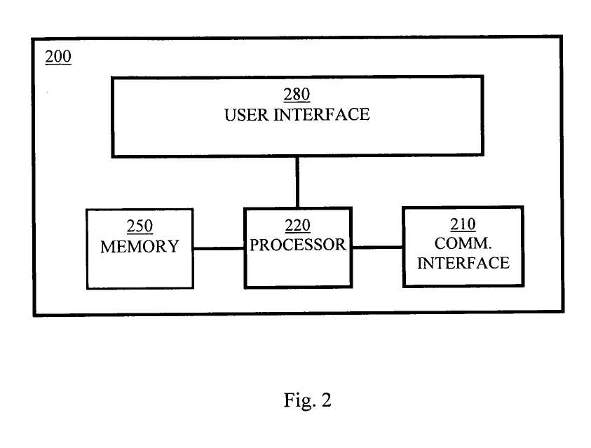

Reference is made now to FIG. 2, which illustrates system 200 for testing, according to an embodiment of the invention. System 200 includes processor 220, memory unit 250, and may include user interface 280, and/or communication interface 210. The processor 220 may be configured to carry out one or more of any of the methods referred to above. The Memory unit 250 may include code that is executable by the processor 220 (e.g. instructions for one or more of the stages of the previously discussed methods and/or computer codes). It is noted that memory unit 250 may also be used to store information required for the processing by processor 220. The user interface 280 may be used for receiving information from a user (e.g. test input information, tests results information, test answers from an examinee), and/or for providing information to the user (e.g. evaluation results). The communication interface 210 may be used for receiving and/or providing information to other systems (e.g. systems that participate in the methods, a scanner, a remote computer via e-mail, and so forth).

It will be noted that methods and systems according to embodiments of the present invention may be used by the academy, schools, survey institutes, research institutes, employment services, army units and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for preparing a set of tests comprising:
receiving a set of questions and one set of answers associated with each question of said set of questions, wherein at least one of the answers in each of said set of answers is a correct answer;
scrambling the order of questions to create one scrambled set of questions;
according a scrambling alphanumeric code to the scrambling of said answers, said alphanumeric code to be used for reconstruction of the scrambled questions into their original order;
repeating the steps of scrambling and the step of according to create additional scrambled tests until the set of scrambled tests includes a predefined number of scrambled tests.

2. The method of claim 1 wherein said according of a scrambling alphanumeric code is to be used for reconstructing the scrambled questions into their original order and the scrambled answers into their original order.

3. The method of claim 1 wherein said scrambling alphanumeric code comprises two alphanumeric strings, a first alphanumeric string and a second alphanumeric string.

4. The method of claim 3 wherein one of said scrambling alphanumeric strings is common for all of the tests of said set of tests and wherein the remaining alphanumeric strings is unique for each test of said set of tests.

5. The method of claim 3 wherein said scrambling alphanumeric code is the only code required to enable reconstruction of said scrambled questions and said scrambled answers.

6. The method of claim 3 wherein said scrambling alphanumeric code is printed on the face of its respective test.

7. The method of claim 1, wherein said set of questions and said associated sets of answers contain data in one or more of the formats in a list comprising textual format, graphical format, an image format and equation objects.

8. The method of claim 1, wherein each question of said set of questions is contained in a block with its respective addable information, said information is in one or more formats from a list comprising text, image, graphics and equation.

9. A storage medium with executable program stored thereon which, when executed, performs:
receiving a set of questions and one set of answers associated with each question of said set of questions, wherein at least one of the answers in each of said set of answers is a correct answer;
scrambling the order of questions to create one scrambled set of questions;
according a scrambling alphanumeric code to the scrambling of said answers, said alphanumeric code to be used for reconstruction of the scrambled questions into their original order;
repeating the steps of scrambling and the step of according to create additional scrambled tests until the set of scrambled tests includes a predefined number of scrambled tests.

10. The storage medium of claim 9, wherein said according of a scrambling alphanumeric code is to be used for reconstructing the scrambled questions into their original order and the scrambled answers into their original order

11. The storage medium of claim 9, wherein said scrambling alphanumeric code comprises two alphanumeric strings, a first alphanumeric string and a second alphanumeric string.

12. The storage medium of claim 11, wherein one of said scrambling alphanumeric strings is common for all of the tests of said set of tests and wherein the remaining alphanumeric strings is unique for each test of said set of tests.

13. The method of claim 11 wherein said scrambling alphanumeric code is the only code required to enable reconstruction of said scrambled questions and said scrambled answers.

14. The method of claim 11 wherein said scrambling alphanumeric code is printed on the face of its respective test.

15. The method of claim 1, wherein said set of questions and said associated sets of answers contain data in one or more of the formats in a list comprising textual format, graphical format, an image format and equation objects.
